(19) United States
(12) Patent Application Publication
(10) Pub. No.: US 2008/0292909 A1
(43) Pub. Date: Nov. 27, 2008

(54) MAGNETIC RECORDING MEDIUM AND MAGNETIC STORAGE APPARATUS

(75) Inventors: Satoshi Igarashi, Higashine (JP); Akira Kikuchi, Higashine (JP); Isatake Kaitsu, Kawasaki (JP); Ryosaku Inamura, Kawasaki (JP); Kenji Sato, Kawasaki (JP); Shinya Sato, Higashine (JP); Hideaki Takahoshi, Higashine (JP); Atsushi Endo, Higashine (JP); Hisato Shibata, Higashine (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/114,431

(22) Filed: May 2, 2008

(30) Foreign Application Priority Data
May 22, 2007 (JP) 2007-135972

(51) Int. Cl. G11B 5/706

(52) U.S. Cl. 428/846.5; 428/846.7; 428/846.9; 428/846

(57) ABSTRACT

This magnetic recording medium has a substrate, a nonmagnetic granular layer formed above the substrate and a recording layer formed on the nonmagnetic granular layer. The nonmagnetic granular layer is made of CoCr alloy with an hcp or an fcc crystal structure in which a nonmagnetic material segregates virtually-columnar magnetic grains. The magnetic recording medium and the magnetic storage apparatus in which the medium is used have improved reading/writing performances.

### FIELD OF THE INVENTION

The Present invention relates to a magnetic recording medium and a magnetic storage apparatus, specifically relates to a magnetic recording medium and a magnetic storage apparatus for high density recording.

### BACKGROUND OF THE INVENTION

With the development of information processing technology, a magnetic storage apparatus used as an external storage apparatus of a computer is required to have improved performance such as a high-capacity and a high speed transfer. To this end, perpendicular recording technology has been developed in order to achieve a magnetic recording with a high recording density in recent years.

For a perpendicular magnetic recording medium, it is helpful to reduce noise generated from a recording layer (or a magnetic layer) thereof to realize the high recording density of a longitudinal magnetic recording layer. In a conventional way, the noise has been reduced by enhancing a coercitivity of the recording layer or refining magnetic grains composing the magnetic layer.

In order to enhance the coercitivity of the recording layer or refining the magnetic grains of the recording layer, it is relatively effective to: construct the recording layer into a double-layered structure; construct the recording layer in a granular layer; and form a Ru intermediate layer under the recording layer. The double-layered structure and the granular layer have been presented in, e.g., Japanese Laid-open Patent Publication 2006-309919. By constructing the granular recording layer, oxide segregates the magnetic grains, thereby better segregating magnetically the magnetic grains from each other. The Ru intermediate layer is formed to facilitate the separation of the magnetic grains in the recording layer.

Yet, constructing the double-layered recording structure or the granular recording layer, or forming the Ru intermediate layer under the recording layer still remains an issue vis-avis further improvement of reading/writing performance. This is considered to be attributed to insufficient magnetic separation of the magnetic grains in the recording layer. The reading/writing performance can be expressed with a signal-to-noise-ratio (SNR), VMM2L giving an indication of an error rate and an effective track width W_{CW}.

This effective track width W_{CW} is an effective width of a track determined by measuring a writing width of the magnetic head from a profile obtained by writing/reading data by moving the magnetic head in the track width direction on the magnetic recording medium.

### SUMMARY OF THE INVENTION

In accordance with an aspect of an embodiment, a magnetic recording medium has a substrate, a nonmagnetic granular layer formed above the substrate and a recording layer formed on the nonmagnetic granular layer. The nonmagnetic granular layer is made of CoCr alloy with an hcp or an fcc crystal structure in which a nonmagnetic material segregates virtually-columnar magnetic grains.

Accordingly, an object of the present invention is to provide a magnetic recording medium and a magnetic storage apparatus whose reading/writing performances are further improved.

### BRIEF DESCRIPTION OF THE DRAWINGS

The present invention will be explained with reference to the accompanying drawings.

FIG. 1 is a sectional diagram illustrating part of the magnetic recording medium in a first embodiment of the present invention.

FIG. 2 is a sectional diagram illustrating part of the magnetic recording medium in the second embodiment of the present invention.

FIG. 3 shows the reading/writing performances of the magnetic recording medium in the first and the second embodiments.

FIG. 4 is a sectional diagram illustrating part of the magnetic recording medium in a third embodiment of the present invention.

FIG. 5 shows the coerctivity of the recording layer where a thickness of a nonmagnetic granular layer is adjusted to fix a summation of thicknesses of the intermediate layer and the nonmagnetic granular layer.

FIG. 6 shows magnetically separating degrees of the magnetic grains of the lower granular layer in the recording layer where a thickness of a nonmagnetic granular layer is adjusted to fix a summation of thicknesses of the intermediate layer and the nonmagnetic granular layer.

FIG. 7 shows the reading/writing performances of the magnetic recording medium in the third embodiment.

FIG. 8 shows the reading/writing performances of the magnetic recording medium in the third embodiment.

FIG. 9 shows a comparative example where the lower granular layer is formed on the intermediate layer.

FIG. 10 shows the third embodiment wherein the nonmagnetic granular layer is formed between the intermediate layer and the lower granular magnetic layer.

FIG. 11 is a sectional diagram illustrating part of the magnetic storage apparatus using one of the embodiments of the present invention.

FIG. 12 is a plan view illustrating part of the magnetic storage apparatus of FIG. 11.

### DETAILED DESCRIPTION

Embodiments of the present invention will be described in detail below with reference to the accompanying drawings.

In this embodiment, a recording layer is formed on a nonmagnetic granular layer in a magnetic recording medium. Forming the nonmagnetic granular layer improves the reading/writing performances of the magnetic recording medium. It is considered that the nonmagnetic granular layer contributes to improve the magnetic separation of the magnetic grains in the recording layer. Alternatively, the nonmagnetic granular layer can be formed on the intermediate layer. When the nonmagnetic granular layer is formed on an intermediate layer, the magnetic separation of the magnetic grains in the recording layer is further improved.

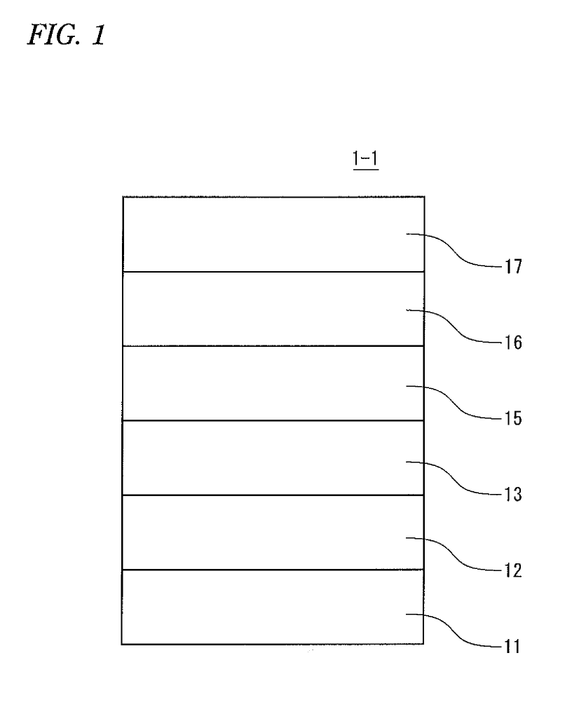

FIG. 1 is the sectional diagram illustrating part of the magnetic recording medium in the first embodiment of the present invention. In this embodiment, the present invention is adopted to the perpendicular magnetic recording medium.

The magnetic recording medium 1-1 shown in FIG. 1 has a structure constructed of an APS-SUL (anti-parallel structure-soft magnetic underlayer) 12 made of Co alloy, an underlayer 13 made of Ni alloy, a nonmagnetic granular layer 15, a recording layer 16 and a protective layer 17 on a glass substrate 11. The protective layer 17 can be made of, e.g., DLC (diamond-like carbon) and a lubricant layer (not illustrated) can be formed thereon.

Thicknesses of the APS-SUL 12 and the underlayer 13 are respectively approximately 50 nm and 5 nm here. A thickness of the protective layer 17 is approximately 6-10 nm here. Materials and structures of members forming the lower part of the magnetic recording medium such as the substrate 11, the APS-SUL 12, the underlayer 13 are not limited as shown in embodiments later described. For example, the underlayer 13 is not necessarily composed of the Ni alloy but also can be composed of other alloys such as Ta, Ti or Co alloys that have an fcc crystal structure and can control an orientation of an upper layer.

The nonmagnetic granular layer 15 is composed of CoCr alloy having an hcp crystal structure or the fcc crystal structure such that substantially-columnar magnetic grains are segregated with nonmagnetic material. A thickness of the nonmagnetic granular layer 15 is approximately 1-8 nm here. The CoCr alloy is made of CoCrX₁ alloy, and the X₁ contains one or more elements selected from among Pt, Ta and Ru. The nonmagnetic material contains at least one element selected from among oxides such as SiO₂, TiO₂, Cr—O_{X}, Ta₂O₅, and ZrO₂ and nitrides such as SiN, TiN, CrN, TaN, ZrN. The nonmagnetic granular layer 15 acts to orient the magnetic grains of the recording layer 16 deposited on its surface.

The recording layer 16 is composed of the Co alloy having the hcp crystal structure such that the virtually-columnar magnetic grains are segregated with the nonmagnetic material, and its thickness is approximately 8-12 nm here. The Co alloy is made of CoFe, CoCr, CoCrPt and CoCrPtB. The nonmagnetic material contains at least one element selected from among the oxides such as SiO₂, Tio₂, Cr—O_{X}, Ta₂O₅, and ZrO₂ and nitrides such as SiN, TiN, CrN, TaN and ZrN. The recording layer 16 can have a single layer structure or a multilayer structure.

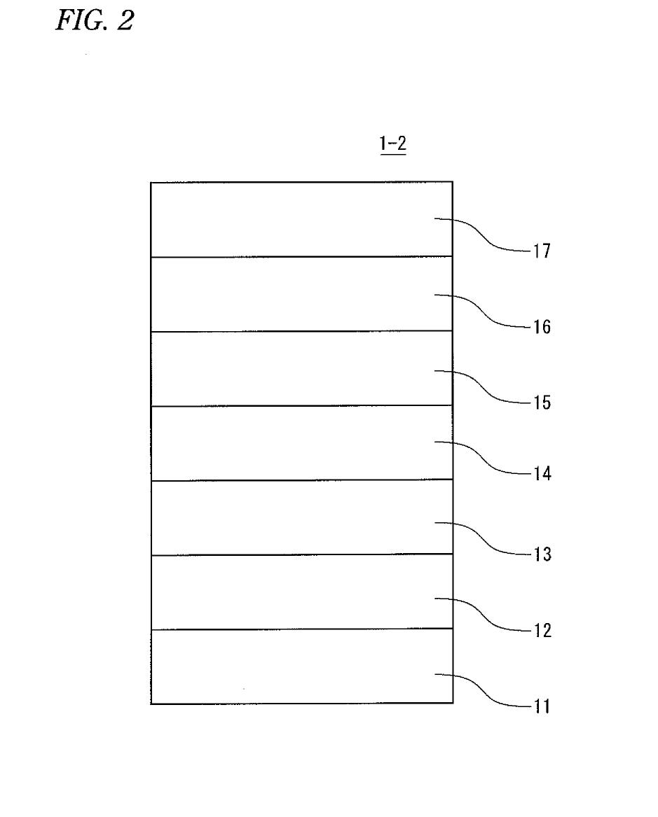

FIG. 2 is a sectional diagram of part of the magnetic recording medium in the second embodiment of the present invention. In this embodiment, the present invention is adopted to the perpendicular magnetic recording medium. In FIG. 2, the same parts of the sectional diagram shown in FIG. 1 are denoted with the same reference character, and descriptions of them will be omitted.

The magnetic recording medium 1-2 shown in FIG. 2 has a structure constructed of the APS-SUL 12 made of Co alloy, the underlayer 13 made of the Ni alloy, the intermediate layer 14, the nonmagnetic granular layer 15, the recording layer 16 and the protective layer 17 on the glass substrate 11. On the protective layer 17, the lubricant layer (not illustrated) can be formed. The intermediate layer 14 is made of the Ru or the RuX₂ alloy having the hap structure. A thickness of the intermediate layer 14 is approximately 15-21 nm. The X₂ is at least one element selected from among Co, Cr, W, Re.

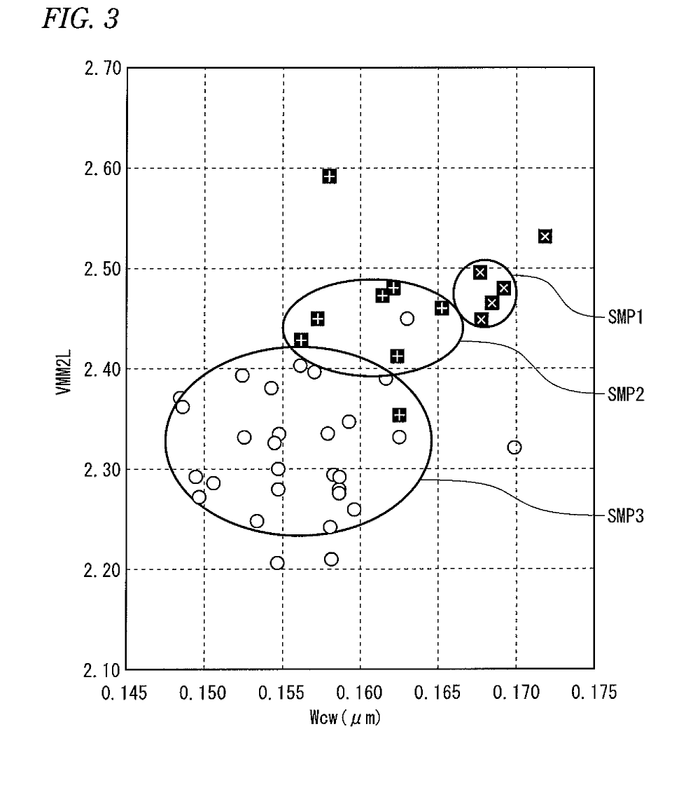

FIG. 3 shows the reading/writing performances of the magnetic recording medium 1-1 and 1-2. In FIG. 3, a vertical axis shows VMM2L indicating an error rate and a horizontal axis shows the effective track width W_{CW}. FIG. 3 shows actual measurement values obtained by measuring samples SMP1, SPM2 and SMP3 by a reading/writing tester having a 200 Gbps-capable head. Conditions such as compositions and thicknesses of respective samples SMP1, SMP2 and SMP3 are the same except for existence/nonexistence of the nonmagnetic granular layer 15 and the Ru intermediate layer. The sample SMP1 is a conventional magnetic recording medium wherein the nonmagnetic granular layer 15 shown in FIG. 1 is substituted for the Ru intermediate layer. The sample SMP2 is the magnetic recording medium 1-1 shown in FIG. 1. The sample SMP3 is the magnetic recording medium 1-2 shown in FIG. 2. The substrate, the APS-SUL, the underlayer, the intermediate layer, the nonmagnetic granular layer, the recoding layer and the protective layer are made of glass, the Co alloy, the Ni alloy, Ru, CoCr—SiO₂, CoCrPt—TiO₂ and the DLC, respectively. The nonmagnetic granular layer here made of CoCr—SiO₂ contains 40 at. % or less of Cr and 8 mol % or less of SiO₂ and a thickness thereof is 4 nm. In FIG. 3, white X marks (in black boxes) indicate data of the sample SMP1 and white+marks (in black boxes) indicate data of the sample SMP2, and circles indicate data of the sample SMP3.

For the sample SMP2, it is confirmed that its effective track width W_{CW} can be narrowed approximately 8 nm compared to the sample 1. For the sample 3, the VMM2L can be decreased 0.2 compared to the sample 1 where its effective track width W_{CW} is the same, while if the VMM2 is the same, the effective track width W_{CW} can be narrowed approximately 13 nm. Further, comparing the sample SMP2′ and the sample SPM3′ having the nonmagnetic granular layers composed of CoCrX₁—SiO₂ to the sample SMP1, even where X₁ contains one or more element selected from among Pt, Ta and Ru, the same improvement effect can be seen. Judging from the fact that forming the nonmagnetic granular layer 15 improves the reading/writing performances, the nonmagnetic granular layer 15 apparently accelerates the magnetic separation of the magnetic grains in recording layer 16. Again, where the nonmagnetic granular layer 15 is formed on the intermediate layer 14, the magnetic separation of the magnetic grains in the recording layer can be further accelerated.

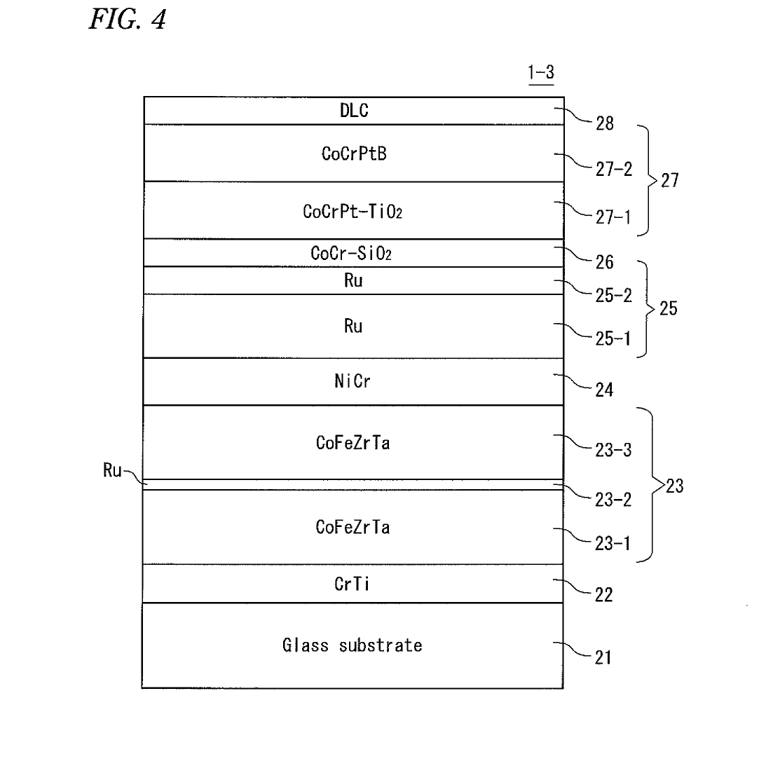

FIG. 4 is the sectional diagram illustrating part of the magnetic recording medium in the third embodiment of the present embodiment. The present invention is adopted to the perpendicular magnetic recording medium.

A magnetic recording medium 1-3 shown in FIG. 4 has a structure constructed of a seed layer 22, a soft magnetic underlayer 23, an orientation control layer (or an underlayer) 24, an intermediate layer 25, a nonmagnetic granular layer 26, a recoding layer 27 and a protective layer 28 on a glass substrate 21. The lubricant layer (not illustrated) can be formed on the protective layer 17. In this embodiment, the recording layer 27 has a multiple layer structure.

The seed layer 22 is composed of an approximately 2-10 nm thickness of CrTi. The soft magnetic underlayer 23 is composed of, e.g., a lower underlayer 23-1 made of approximately 5-30 nm thickness of CoFeZrTa, a magnetic domain control layer 23-2 made of approximately 0.4-3 nm thickness of Ru and an upper underlayer 23-3 made of CoFeZrTa. The CoFezrTa upper underlayer 23-3 is of, e.g., approximately 5-30 nm in thickness, containing 40-50 at. % of Fe, 4-9 at. % of Zr and 2-10 at. % of Ta. The orientation control layer 24 is, e.g., constructed of approximately 2-15 nm thickness of NiCr. The intermediate layer 25 is composed of, e.g., a lower nonmagnetic layer 25-1 made of approximately 3-15 nm thickness of Ru and an upper nonmagnetic layer 25-2 made of approximately 3-10 nm thickness of Ru. The nonmagnetic granular layer 26 is composed of, e.g., approximately 0.5-5 nm thickness of CoCr—SiO₂, containing 30-50 at. % of the Cr and 4-12 mol. % of SiO₂. The recording layer 27 is composed of, e.g., a lower granular magnetic layer 27-1 made of CoCrPt—TiO₂, acting as a main recording layer and an upper magnetic layer 27-2 made up of CoCrPtB, acting as a recording auxiliary layer 27-2. The CoCrPtB upper magnetic layer 27-2 is of, e.g., approximately 3-12 nm in thickness, containing 5-25 at. % of Co, 5-25 at. % of Pt and 1-15 at. % of B. The protective layer 17 is composed of approximately 4 nm thickness of the DLC.

Next, a manufacturing method of the magnetic recording medium 1-3 shown in FIG. 4 will be described.

Firstly, a rigidity of the surface of the substrate 21 made of a nonmagnetic material such as glass is increased by chemical processing, then the seed layer 22 is formed by growing the CrTi alloy to a thickness of approximately 3 nm by the sputter technique with 0.3-0.8 Pa of sputtering pressures. A growth rate of the seed layer 22 is not specified, however, in this embodiment, it is of 2 nm/sec. With the seed layer 22, the surface condition of the substrate 21 does not affect the layers deposited thereon in the post-processes. Furthermore, the seed layer acts as an adhesive layer adhering the layers with the substrate 21. If a problem on a crystallinity of the layers deposited in the post-processes will not arise without forming the seed layer 22, it is not necessary to form it.

A material of the substrate 21 is not limited to glass. Where the magnetic recording medium 1-3 is a solid medium such as a hard disk, a plastic substrate, an Al alloy substrate plated NiP or a silicon substrate can also be used as the substrate 21. Where the magnetic recording medium 1-3 is a flexible tape-like medium, a PET (poly ethylene terephthalate) substrate, a PEN (poly ethylene naphthalate) substrate or a polyimide substrate can also be used as the substrate 21.

Then, on the seed layer 22, the lower underlayer 23-1 is formed by growing soft magnetic amorphous FeCoZrTa to a thickness of approximately 20 nm by sputtering with 0.3-0.8 Pa sputtering pressures and a 5 nm/sec growth rate. The soft magnetic amorphous material composing the lower underlayer is not limited to FeCoZrTa. An alloy containing any of Fe or Co and one or more additive elements can be also used as the lower underlayer 23-1.

With the sputter method described above, the magnetic domain control layer 23-2 is formed by growing approximately 0.4-3 nm thickness of Ru on the lower underlayer 23-1. A material composing the magnetic domain control layer 23-2 is not limited to Ru, but also can be Rh, Ir and Cu.

Thereafter, the upper underlayer 23-3 is formed by growing the soft magnetic amorphous FeCoZrTa to approximately 20 nm in thickness on the magnetic domain control layer 23-2 with the sputter technique under the same conditions used in forming the lower underlayer 23-1. The amorphous material composing the upper underlayer 23-3 is not limited to FeCoZrTa, but also can be other amorphous material such an alloy containing any of Fe or Co and one or more additive element.

On the seed layer 22, the soft magnetic underlayer 23 having the lower underlayer 23-1, the magnetic domain control layer 23-2 and the upper underlayer 23-3 is formed. For the soft magnetic underlayer 23 having such structure, the magnetic domain control layer 23-2 couples the lower underlayer 23-1 and the upper underlayer 23-3 antiferromagnetically. Therefore, the magnetizations of both underlayers 23-1 and 23-3 are stabilized in a reciprocally anti-parallelism state. Even though the adjacent magnetizations in the upper underlayer 23-3 (or the lower underlayer 23-1) are reversely directed each other in the film plane, in other words, “in face-to-face directions”, the magnetic flux flowing from there will be refluxed in the soft magnetic underlayer 23 because the magnetizations of the upper underlayer 23-3 and the lower underlayer 23-1 are in the anti-parallelism state. Consequently, the magnetic flux originated from the magnetic domain wall is less likely to flow upward of the soft magnetic underlayer 23, thus the magnetic head is not affected by the magnetic flux. Therefore, the spike noise generated in reading attributed to the magnetic flux will be reduced.

In addition, to reduce the spike noise, there is another structure such that a single-layer soft magnetic underlayer is formed on the antiferromagnetic layer. In this case, the antiferromagnetic layer is composed of. e.g., IrMn or FeMn.

Then, the orientation control layer 24 is formed by growing, e.g., soft magnetic Ni₉₀Cr₁₀ to approximately 5 nm in thickness on the soft magnetic underlayer 23 by the sputter technique with 0.3-0.8 Pa sputtering pressures and a 2 nm/sec sputtering rate. The NiCr layer constructing the orientation control layer 24 can have a fcc crystal structure by using a FeCo alloy amorphous material for the upper underlayer 23-3. The orientation control layer 24 having such fcc crystal structure can be accomplished using NiCr, or any of NiFeCr, Pt, Pd, NiFe, NiFeSi, Al, Cu or In, or such alloys.

Composing the orientation layer 24 of a soft magnetic material such as NiFe makes the orientation control layer 24 act as the upper underlayer 23-3, which produces the same effect of shortening a substantial distance from the magnetic head to the upper underlayer 23-3, allowing the magnetic head to read the information written on the magnetic recording medium 1-3 with a good sensitivity.

Next, the lower nonmagnetic layer 25-1 is formed by growing Ru to approximately 10 nm in thickness on the orientation control layer 24 by the sputter technique with 4-10 Pa sputtering pressures and with 2-5 nm/sec sputtering rates. Thereafter, the upper nonmagnetic layer 25-2 is formed by growing Ru to approximately 5 nm in thickness on the lower nonmagnetic layer 25-1 by the sputter technique with 4-10 Pa sputtering pressures and a 0.5 nm/sec sputtering rate, which is lower than the sputtering rate used with the lower nonmagnetic layer 25-1. The lower nonmagnetic layer 25-1 and the upper nonmagnetic layer 25-2 form the intermediate layer 25.

Ru layers constricting the nonmagnetic layers 25-1 and 25-2 have an hcp crystal structure that has a good lattice matching with the fcc crystal structure of the soft magnetic layer of the orientation control layer 24. With such mechanism of the orientation control layer 24, the nonmagnetic layer 25-1 and 25-2 having favorable crystallinities oriented in one direction are grown.

The nonmagnetic layer 25-1 and 25-2 composing the intermediate layer 25 can be made of Ru having the hcp crystal structure, but can also be made of RuX₂ alloy having the hcp crystal structure. In this case, X₂ is an element selected from among Co, Cr, W or Re.

Then, the nonmagnetic granular layer 26 is formed by growing (Co₆₀Cr₄₀)₉₄—(SiO₂)₆ to approximately 2 nm in thickness by the sputter technique with 0.5-7 Pa sputtering pressures and a relatively low sputtering rate, 0.5 nm/sec. The nonmagnetic granular layer 26 is in a state that the virtually-columnar magnetic grains composed of CoCr are segregated from the nonmagnetic material that contains at least one element selected from among the oxides such as SiO₂, Tio₂, Cr—O_{X}, Ta₂O₅, and ZrO₂ and the nitrides such as SiN, TiN, CrN, TaN and ZrN.

Then a Ar gas mixed with a slight amount of O₂, e.g., 0.2-2% flow ratio of O₂, is injected into a sputter chamber as sputter gas to stabilize the pressure at a relatively high pressure, approximately 3-7 Pa. The temperature of the substrate is kept relatively low at approximately 10-80 degrees C. In this state, Co₆₆Cr₁₄Pt₂₀ and Ti_{0.2} are sputtered by applying approximately 400-100 W of high frequency current between a target and the substrate 21 having the nonmagnetic granular layer 26 thereon. A frequency of the high frequency current here can be 13.56 MHz. Substituting for the high frequency current, DC current on the order of 400-1000 W can be used for conducting a discharge in the sputter chamber.

As described above, using the sputter technique with a relatively high pressure (approximately 3-7 Pa) and relatively low temperatures (approximately 10-80 degrees C.), a layer in a lower density can be formed compared to the case of forming the layer with a relatively low pressure and a relatively high temperature. Therefore, on the nonmagnetic granular layer 26, the target materials, Co₆₆Cr₁₄Pt₂₀ and TiO₂ are not mixed together. Then the main recording layer, i.e., the lower granular magnetic layer 27-1, with the granular structure wherein the nonmagnetic material composed of Tio₂ segregates the magnetic grains composed of Co₆₆Cr₁₄Pt₂₀ is formed. For such lower granular magnetic layer 27-1, a content percentage of the nonmagnetic material is preferably approximately 5-12 mol %. In this embodiment, the (Co₆₆Cr₁₄Pt₂₀)₉₂(Tio₂)₈ containing an approximately 8 mol % of the nonmagnetic material is formed as the lower granular magnetic layer 27-1. A thickness of the lower granular magnetic layer 27-1 is not specified. However, in this embodiment, the thickness of the lower granular magnetic layer 27-1 is specified as approximately 12 nm with 3 nm/sec sputtering rate.

Of the intermediate layers 25 formed under the lower granular magnetic layer 27-1, the upper nonmagnetic layer 25-2 with the hcp crystal structure acts to orient the magnetic grains of the lower granular magnetic layer 27-1 in the perpendicular direction to the surface thereof. Thus, the magnetic grains of the lower granular magnetic layer 27-1 have the hcp crystal structure structuring perpendicular direction as with the upper nonmagnetic layer 25-2, and height directions of hexagonal cylinders in the hcp crystal structure are parallel to the direction of an axis of easy magnetization. Thus, the lower granular magnetic layer 27-1 shows a perpendicular magnetic anisotropy.

For the main recording layer composed of the lower granular magnetic layer 27-1 having such granular structure, the magnetic grains are decoupled from each other and their axis of easy magnetization is vertical. Thus, noise generated from the main recording layer can be reduced.

Further, for the magnetic grains of the lower granular magnetic layer 27-1, where their Pt contained amount is 25 at. % or greater, the magnetic anisotropic constant Ku is decreased. Therefore, the Pt contained in the magnetic grain is preferably less than 25 at. %.

Further, using the Ar gas mixed with the slight amount (0.2-2% flow ratios) of O₂ as the sputter gas accelerates the magnetic separation of the magnetic grains in the lower granular magnetic layer 27-1, improving electromagnetic conversion characteristics.

The magnetic separation of the magnetic grains in the lower granular layer 27-1, i.e., widening intervals between the magnetic grains is feasible by comparatively increasing the degree of the surface roughness of the upper nonmagnetic layer 25-2 under the lower granular magnetic layer 27-1. To increase the degree of the surface roughness of the upper nonmagnetic layer 25-2, Ru in the upper nonmagnetic layer 25-2 is sputtered at a low sputtering rate, 0.5 nm/sec.

The nonmagnetic material used for the lower granular magnetic layer 27-1 is not limited to TiO₂, but also can be other oxide (e.g., SiO₂, Cr—Oₓ, Ta₂O₅ and ZrO₂) or other nitride (e.g., SiN, TiN, CrN, Tan, ZrN). Alternatively, the magnetic grains used for the lower granular magnetic layer 27-1 can be CoFe or CoFe alloy. When the magnetic grains are composed of the CoFe alloy, the magnetic grains are preferably constructed into a HCT (honeycomb chained triangle) structure by being subjected to heat treatment. Further, Cu or Ag can be added to the CoFe alloy.

Next, with sputtering using the Ar gas as a sputter gas, the CoCrOPtB upper magnetic layer 27-2 acting as the recording auxiliary layer is formed on the lower granular magnetic layer 27-1 by growing an alloy containing Co and Cr (CoCr alloy), e.g., Co₆₇Cr₁₉Pt₁₀O₄, to approximately 6 nm in thickness. A sputtering condition of the CoCrOPtB upper magnetic layer 27-2 is not specified. However, in this embodiment, the sputtering pressure and the sputtering rate are specified as 0.3-0.8 Pa and 2 nm/sec, respectively.

The CoCrPtB upper magnetic layer 27-2 acting as the recording auxiliary layer has the same hcp crystal structure of the lower granular magnetic layer 27-1 formed under the CoCrPtB upper magnetic layer 27-2, acting as the main recording layer. Thus, the lattice matching of the magnetic grains of the CoCrPtB upper magnetic layer 27-2 and the lower granular magnetic layer 27-1 is high, so the CoCrPtB upper magnetic layer 27-2 can be grown on the lower granular magnetic layer 27-1 with a favorably crystallinity.

Thereafter, the protective layer 28 composed of the DLC is deposited on the recording layer 27 (the lower granular magnetic layer 27-1 and the CoCrPtB upper magnetic layer 27-2) by RF-CVD (radio frequency-chemical vapor deposition) using a C₂H₂ as a reactant gas to 4 nm in thickness. A deposition condition for depositing the protective layer 28 is, e.g., approximately 4 Pa of the deposition pressure, 1000 W of high frequency current, 200V of bias current applied between the substrate 21 having its CoCrPtB upper magnetic layer 27-2, and a shower head in the chamber.

In that manner, the magnetic recording medium 1-3 having a structure illustrated in FIG. 4 is produced.

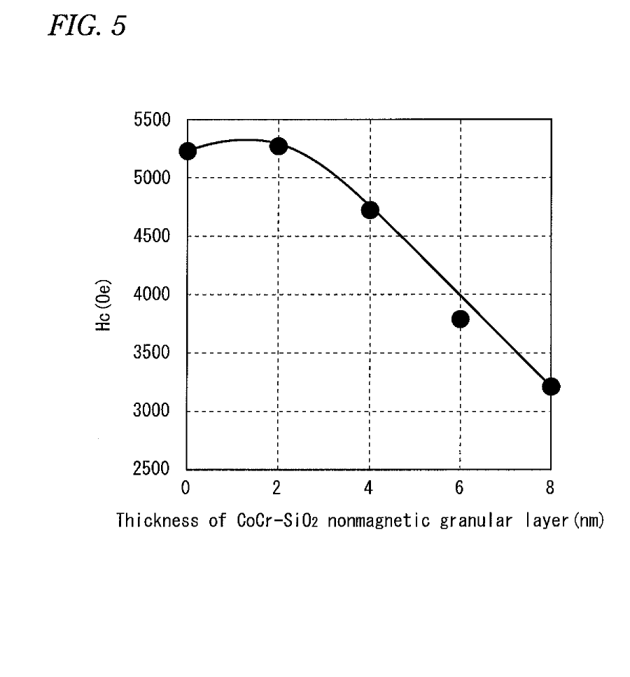

FIG. 5-FIG. 8 show the characteristics of the magnetic recording medium 1-3 shown in FIG. 4.

FIG. 5 shows a coercitivity H_{C} of the recording layer 27 where the thickness of the CoCr—SiO₂ nonmagnetic granular layer 26 is changed in order to fix a summation of the thicknesses of the Ru intermediate layer 25 and the CoCr—SiO₂ nonmagnetic granular layer 26 to 8 nm. FIG. 5 shows actual measurement values measured by a magnetization measuring device using a polar Kerr. In FIG. 5, a vertical axis indicates the actual measurement values of the coercitivity H_{C} and a horizontal axis indicates the thicknesses of the CoCr—SiO₂ nonmagnetic granular layer 26.

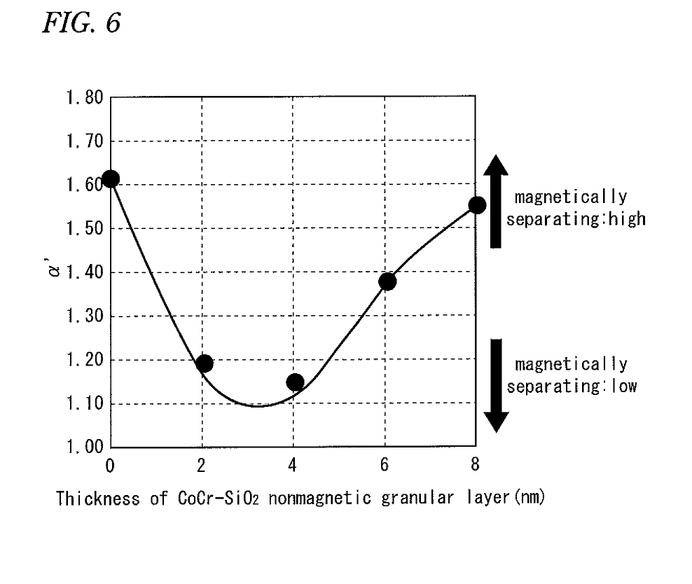

FIG. 6 shows magnetic separation degrees α′ of the magnetic grains in the lower granular magnetic layer 27-1 in the recording layer 27 where the thickness of the CoCr—SiO₂ nonmagnetic granular layer 26 is changed in order to fix the summation of the thicknesses of the Ru intermediate layer 25 and the CoCr—SiO₂ nonmagnetic granular layer 26 to 8 nm. FIG. 6 shows the actual measurement values measured by the magnetization measuring device using the polar Kerr. In FIG. 6, a vertical axis indicates the actual measurement values of the magnetic separation degrees α′ of the magnetic grains, and a horizontal axis indicates the thickness of the CoCr—SiO₂ nonmagnetic granular layer 26. When the magnetically separating degree of the magnetic grains is higher, the values of α′ is less. Generally, α′ indicates a gradient of a magnetization loop in proximity of H_{C} where a magnetic field is defined as Oe and the magnetization is defined as Gauss. The α′ values indicate the gradient of a magnetization loop in proximity of H_{C} where a saturated magnetization of the recording layer is defined as 500 emu/cc.

As shown in FIG. 5, the coercitiviy H_{C} is maximized where the thickness of the CoCr—SiO₂ nonmagnetic granular layer 26 is approximately 2 nm, and as shown in FIG. 6 α′ is minimized where the thickness is approximately 3 nm.

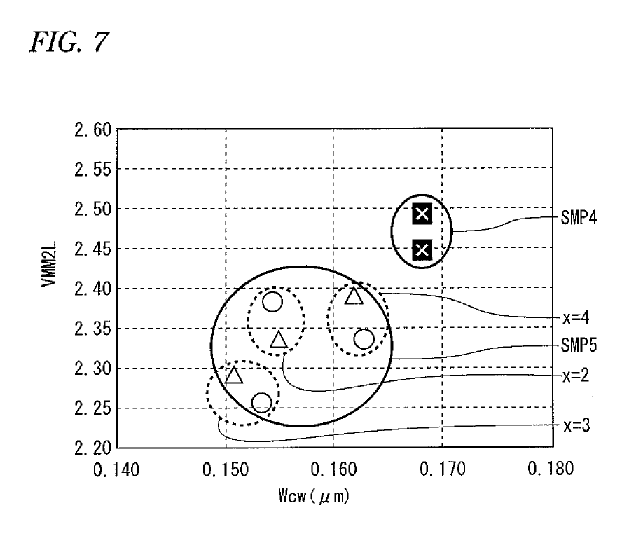

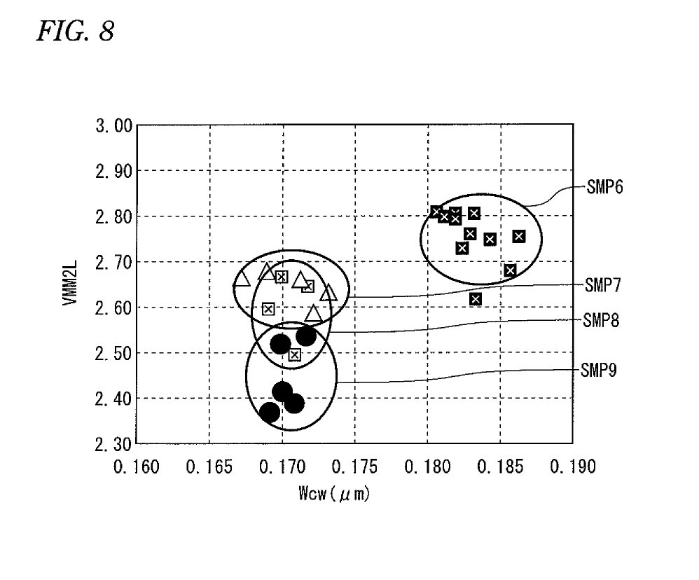

FIG. 7 and FIG. 8 show the reading/writing performances of the magnetic recording medium 1-3. In FIG. 7 and FIG. 8, vertical axes show the VMM2Ls indicating the error rate and horizontal axes show the effective track widths W_{CW}.

FIG. 7 shows actual measurement values obtained by measuring the sample SMP4 and SMP5 by the reading/writing tester having the 200 Gbps-capable head. The samples SMP4 and SMP5 are measured under the same conditions (compositions and thicknesses) except for the existence/nonexistence of the nonmagnetic granular layer 26. The sample SMP4 is the conventional magnetic recording medium not having the nonmagnetic granular layer 26 as per FIG. 4. The sample SMPS is the magnetic recording medium 1-3 shown in FIG. 4. As for the nonmagnetic granular layer composed of CoCr—SiO₂, a contained amount of Cr is specified as 40 at. % or less and a content percentage of SiO₂ is specified as 6 mol % or 8 mol % or less and a thickness is specified as 2-4 nm, based on the actual measurements of FIGS. 5 and 6. In FIG. 7, the white X marks (in the black boxes) indicate data of the sample SMP4, the white circles indicate data on the sample SMP4 containing a 6 mol % of SiO₂ and the white triangles indicate data of the sample SMP4 containing a 8 mol % of SiO₂. X=2, 3 and 4 in FIG. 7 indicate thicknesses of the nonmagnetic granular layers composed of CoCr—SiO₂, 2 nm, 3 nm and 4 nm, respectively.

For the sample SMP5, the effective track widths W_{CW} are narrowed approximately 10 nm compared to the sample SMP4. For the sample SMPS, the VMM2Ls are decreased approximately 0.15 compared to the sample SMP4. Judging from the fact that forming the nonmagnetic granular layer 26 improves the reading/writing performances, the nonmagnetic granular layer 26 apparently accelerates the magnetic separation of the magnetic grains in recording layer 27. Forming the nonmagnetic granular layer 26 on the intermediate layer 25 further improves the magnetic separation of the magnetic grain.

FIG. 8 shows actual measurement values of samples SMP6, SMP7, SMP8 and SMP9 measured by the reading/writing tester having the 200 Gbps-capable head. The samples SMP6, SMP7, SMP8 and SMP9 are measured under the same conditions (the compositions and thicknesses) except for the existence/nonexistence of the nonmagnetic granular layer 26. The sample SMP6 is the conventional magnetic recording medium not having the nonmagnetic granular layer 26 as per FIG. 4. The samples SMP7, SMP8 and SMP9 are the magnetic recording medium 1-3 shown in FIG. 4. For the nonmagnetic granular layer composed of CoCr—SiO₂, the content amount of Cr is defined as 40 at. % or less and the content amount of Tio₂ or SiO₂ is defined as 6 mol % or less and its thickness is defined as 2 nm. The nonmagnetic granular layer of the sample SPM7 is composed of CoCrRu—TiO₂, while the nonmagnetic granular layer of the sample SPM8 is composed of CoCrRu—SiO₂. The nonmagnetic granular layer of the sample SMP9 is composed of CoCr—SiO₂. In FIG. 8, the white X marks (in the black boxes), the white triangles, the black Xs (in the white boxes) and the black circles indicate data of the sample SPMG, data of the sample SPM7, data of the sample SPM8, and data of the sample SPM9, respectively.

For the samples SMP7-SMP9, the effective track widths W_{CW} are narrowed compared to the sample SMP6. In addition, in the samples SMP7-SMP9, the VMM2Ls are also improved compared to the sample SMPG. Thus, the same improvement effect can be attained with CoCrRu as the nonmagnetic material as with CoCr. Likewise, the same improvement effect can be attained with nitride such as TiN as an additive to the nonmagnetic material, as with the oxide such as SiO₂. Judging from the fact that forming the nonmagnetic granular layer 26 apparently improves the reading/writing performances, the nonmagnetic granular layer 26 accelerates the magnetic separation of the magnetic grains in recording layer 27. Forming the nonmagnetic granular layer 26 on the intermediate layer 25, further improves the magnetic separation of the magnetic grain.

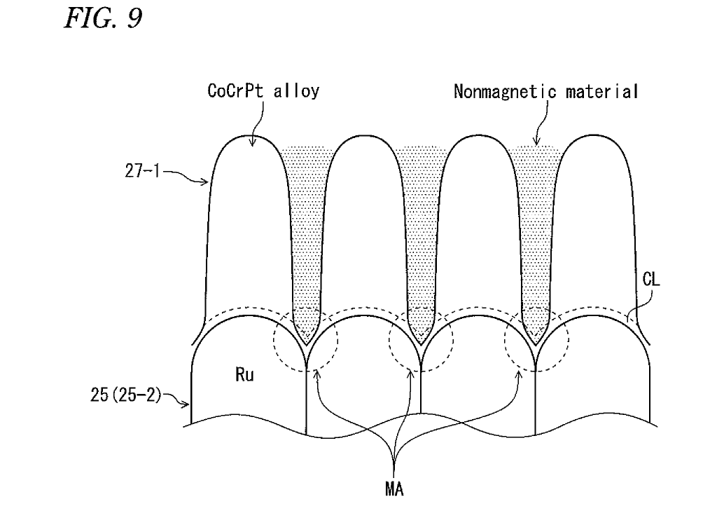

FIG. 9 shows a comparative example where the lower granular magnetic layer 27-1 made of the CoCrPt alloy is formed directly on the intermediate layer 25 (the upper nonmagnetic layer 25-2) composed of Ru. Since Co has a higher wettability than Ru, when the granular magnetic layer in which the nonmagnetic material (such as the oxide or the nitride) segregates the virtually-columnar magnetic grains (the CoCrRt alloy) is grown on the Ru layer, the granular magnetic layer grows in a lateral direction (CL) in an initial growth stage as per FIG. 9. It is assumed that, at the areas MA enclosed with the dashed line, the magnetic grains are interacting each other. Thus, the magnetic grains are not completely magnetically segregated, which contributes to noise generated from the medium.

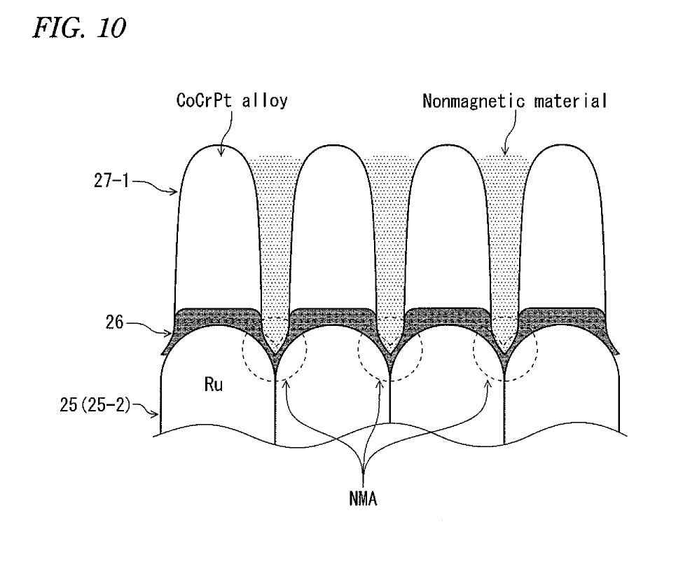

FIG. 10 shows the third embodiment wherein the nonmagnetic granular layer 26 made of the CoCr alloy is formed between the intermediate layer 25 and the lower granular magnetic layer 27-1 made of CoCrPt alloy. In the third embodiment, a portion made at the initial growth stage is composed of the nonmagnetic material (here, the CoCr alloy is used in consideration of the crystal growth of Ru and CoCrPt). As a result, when the nonmagnetic granular layer is connected in the lateral direction at the initial growth stage as per FIG. 10, the magnetic grains in a portion of the granular magnetic layer (NMA: enclosed with the dashed line) do not interact with each other. Thus, the magnetic grains are magnetically segregated well, thereby reduce the noise generated from the medium.

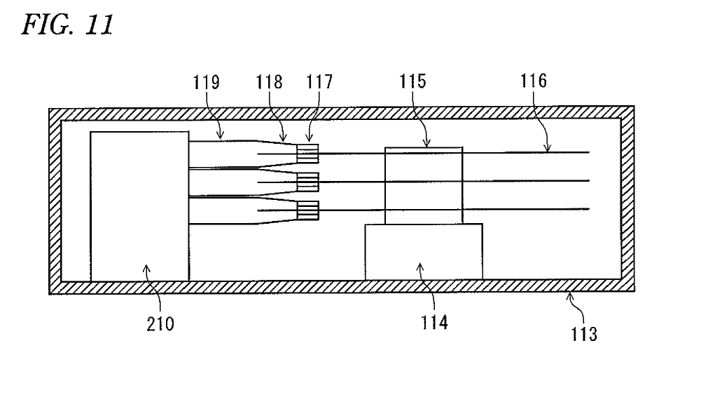

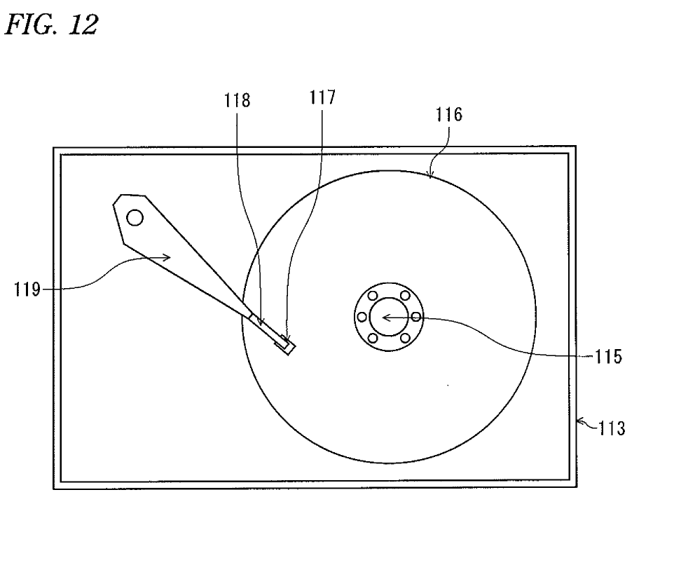

Next, referring to FIG. 11 and FIG. 12, embodiments of the magnetic storage apparatus in the present invention are discussed.

As shown in FIG. 11 and FIG. 12, the magnetic storage apparatus has a motor 114 fixed in a housing 113, a hub 115, a plurality of magnetic recording media 116, a plurality of writing/reading heads 117, a plurality of arms 119 and an actuator device 210. The magnetic recording media 116 are loaded on the hub 115 rotated by the motor 114. Each writing/reading head 117 has a reading head and a writing head. The respective writing/reading heads 117 are attached to an end of correspondent arm 119 via suspensions 118. The arms 119 are operated by the actuator device 210. Detailed description of the basic structure of such magnetic storage apparatus is omitted in this document, since it is publicly known.

In this embodiment, each magnetic recording medium 116 has a structure described in accordance with any of FIG. 1, FIG. 2 or FIG. 4. The number of the magnetic recording media 116 is not limited to 3. It can be 2 or 4 or greater.

The basic structure of the magnetic storage apparatus is not limited to the ones shown in FIG. 11 and FIG. 12. Furthermore, the magnetic recording media used in the present invention is not specified to magnetic disks, but also can be other magnetic recording media such as magnetic tapes or magnetic cards. Again, the magnetic recording media are not necessarily fixed in the housing 113 of the magnetic storage apparatus. They can be portable media to be loaded or unloaded into the housing 113.

In the embodiments described above, the present invention is adopted to the perpendicular magnetic recording medium. However, the present invention is applicable to a longitudinal magnetic recording medium as well. Likewise, for the longitudinal magnetic recording medium, the magnetic separation of the magnetic grains in the recording layer is enhanced by forming the nonmagnetic granular layer beneath the recording layer as presented in the present invention, thereby improving the reading/writing performances.

In accordance with the present invention, the magnetic recording medium and the magnetic storage apparatus with improved reading/writing performances can be achieved.

What is claimed is:

1. A magnetic recording medium, comprising:
a substrate;
a nonmagnetic granular layer formed on said substrate; and
a recording layer formed on said nonmagnetic granular layer,
wherein said nonmagnetic granular layer is made of CoCr alloy with an hcp or an fcc crystal structure in which a nonmagnetic material segregates virtually-columnar magnetic grains.

2. The magnetic recording medium according to claim 1, wherein:
said CoCr alloy is made of CoCrX₁ alloy;
X₁ is an element selected from among Pt, Ta and Ru; and
said nonmagnetic material contains at least one of element selected from among SiO₂, TiO₂, Cr—O_{X}, Ta₂O₅, ZrO₂, SiN, TiN, CrN, TaN and ZrN.

3. The magnetic recording medium according to claim 1, wherein:
said recording layer is composed of Co alloy with the hcp structure in which the nonmagnetic material segregates the virtually-columnar magnetic grains.

4. The magnetic recording medium according to claim 2, wherein:
said recording layer is composed of Co alloy with the hcp structure in which the nonmagnetic material segregates the virtually-columnar magnetic grains.

5. The magnetic recording medium according to claim 3, wherein:
the Co alloy composing said recording layer is an element selected from among CoFe, CrCr, CoCrRt and CoCrRtB; and
the nonmagnetic material composing said recording layer contains at least one element selected from among SiO₂, TiO₂, Cr—O_{X}, Ta₂O₅, ZrO₂, SiN, TiN, CrN, TaN and ZrN.

6. The magnetic recording medium according to claim 4, wherein:
the Co ally composing said recording layer is an element selected from among CoFe, CrCr, CoCrRt and CoCrRtB; and
the nonmagnetic material composing said recording layer contains at least one of element selected from among SiO₂, TiO₂, Cr—O_{X}, Ta₂O₅, ZrO₂, SiN, TiN, CrN, TaN and ZrN.

7. The magnetic recording medium according to claim 1, wherein:
said recording layer is a single layer.

8. The magnetic recording medium according to claim 1, wherein:
said recording layer is constructed of a lower granular magnetic layer and an upper magnetic layer,
the lower granular magnetic layer is made of the Co alloy with the hcp crystal structure in which the nonmagnetic material segregates the virtually-columnar magnetic grains and acts as a main recording layer, and
the upper magnetic layer is formed on the lower granular magnetic layer, made of the Co alloy, and acts as a recording auxiliary layer.

9. The magnetic recording medium according to claim 2, wherein:
said recording layer is constructed of a lower granular magnetic layer and an upper magnetic layer,
the lower granular magnetic layer is made of the Co alloy with the hcp crystal structure in which the nonmagnetic material segregates the virtually-columnar magnetic grains and acts as a main recording layer, and
the upper magnetic layer is formed on the lower granular magnetic layer, made of the Co alloy, and acts as a recording auxiliary layer.

10. The magnetic recording medium according to claim 8, wherein:
the Co alloy composing said lower granular magnetic layer is an element selected from among CoFe, CrCr, CoCrRt and CoCrRtB; and
said nonmagnetic material composing said lower granular magnetic layer contains at least one element selected from among SiO₂, TiO₂, Cr—O_{X}, Ta₂O₅, ZrO₂, SiN, TiN, CrN, TaN and ZrN.

11. The magnetic recording medium according to claim 9, wherein:
the Co alloy composing said lower granular magnetic layer is an element selected from among CoFe, CrCr, CoCrRt and CoCrRtB; and
said nonmagnetic material composing said lower granular magnetic layer contains at least one element selected from among SiO₂, TiO₂, Cr—O_{X}, Ta₂O₅, ZrO₂, SiN, TiN, CrN, TaN and ZrN.

12. The magnetic recording medium according to claim 1, further comprising:
a nonmagnetic intermediate layer,
wherein said nonmagnetic granular layer is formed on said nonmagnetic intermediate layer.

13. The magnetic recording medium according to claim 12, wherein:
said intermediate layer is made of Ru or RuX₂ alloy with the hcp crystal structure, and X₂ contains at least one element selected from among Co, Cr, W and Re.

14. The magnetic recording medium according to claim 12, further comprising:
a soft magnetic underlayer formed above said substrate;
an orientation control layer formed on said soft magnetic underlayer, wherein
said nonmagnetic intermediate layer is formed on said orientation control layer.

15. The magnetic recording layer medium according to claim 14, wherein:
said orientation control layer is made of NiCr.

16. The magnetic recording medium according to claim 14, wherein:
said soft magnetic underlayer is constructed of a lower underlayer, a magnetic domain control layer formed on said lower underlayer, and an upper underlayer formed on said magnetic domain control layer,
the lower underlayer is made of a Co alloy,
the magnetic domain control layer is made of Ru, and
the upper underlayer is made of a Co alloy.

17. The magnetic recording medium according to claim 14, wherein:
said soft magnetic underlayer is an APS-SUL (anti-parallel structure-soft magnetic underlayer) made of a Co alloy.

18. The magnetic recording medium according to claim 14, further comprising:
a seed layer formed on said substrate,
wherein said soft magnetic underlayer is formed on said seed layer.

19. The magnetic recording medium according to claim 18, wherein:
said seed layer is made of CrTi alloy.

20. The magnetic recording medium according to claim 1, wherein:
said substrate is a substrate selected from among a glass substrate, a carbon substrate, a plastic substrate, an Al alloy substrate plated with NiP, a silicon substrate, a PET (poly ethylene terephthalate) substrate, a PEN (poly ethylene naphthalate) substrate and a polyimide substrate.
